(19) United States
(12) Patent Application Publication
(10) Pub. No.: US 2014/0081694 A1
(43) Pub. Date: Mar. 20, 2014

(54) METHODS & SYSTEMS FOR USING VISIBLE MEDIA IN DETERMINING A PHYSICAL LOCATION

(71) Applicants: DAVID A. GRUNBERG, NEW YORK, NY (US); GAGE F. ROMMEL, CHATHAM, NY (US)

(72) Inventors: DAVID A. GRUNBERG, NEW YORK, NY (US); GAGE F. ROMMEL, CHATHAM, NY (US)

(21) Appl. No.: 14/026,749

(22) Filed: Sep. 13, 2013

Related U.S. Application Data
(60) Provisional application No. 61/701,059, filed on Sep. 14, 2012.

(51) Int. Cl. G06Q 10/10

(52) U.S. Cl. CPC G06Q 10/1095
USPC 705/7.19

(57) ABSTRACT

The invention features using visual media to determine the location of an event or a meeting. The same could be used to locate people at an event or location. The invention entails the creation of a meeting scenario with certain invitees in mind, the creation and assignment of a unique visual image specific to the meeting scenario, transmission of the unique image and display of the image for invitees to identify or be directed to the event. The invention may implemented by steps, systems and computer program products which all enable user participation.

### CROSS-REFERENCE TO RELATED APPLICATIONS

This application claims the benefit of, and is related to Applicant's provisional patent application, U.S. Provisional Patent Application No. 61/701,059 titled “METHODS, SYSTEMS & APPARATUS FOR USING VISIBLE MEDIA IN DETERMINING PHYSICAL LOCATION,” filed Sep. 14, 2012.

### FIELD OF THE INVENTION

The present invention is generally related to methods and systems for using visible media to determine the physical location of an event and/or people.

### BACKGROUND OF THE INVENTION

When individuals need to locate each other, sometimes it is difficult for them to find each other in several situations such as a dark environment, a noisy environment, an enforced-silence environment (e.g. a library or a theater), a crowded place, an environment with no cellular wireless service and/or a situation where neither party knows the physical appearance of the other.

For instance, where a meeting organizer wishes to invite one or more others to meet him at a particular place and time, it is difficult (or embarrassing) to locate others in a crowded or dark place. Either he/she would have call out a name loudly, or closely examine faces as he/she navigates through a crowded bar or outdoor concert, etc. Global Positioning System (GPS) may be useful, but only if the meeting is to occur outdoors. Besides, GPS may not be accurate enough in a very crowded place.

### SUMMARY OF THE INVENTION

In light of the foregoing, it is an object of the present invention to provide methods, systems and computer program product to enable two or more people to locate each another quietly, discreetly, and visually, without calling out names or examining faces.

It is an object of the present invention to provide a visual method of finding other people, events or things, while also confirming the identity of same. A meeting or event may be planned by a meeting organizer for a particular place and time, and a unique image, media or animation is assigned to the meeting. The unique image, media or animation is given to all meeting attendees/invitees ahead of time, so they will be able to find, recognize, and confirm the legitimacy of the other attendees.

Advantages of the present invention include saving people from having to examine faces closely or to call out a name or ask “are you so-and-so?”. The present invention is also advantageous as people will be able to find and identify each other even in low-light situations or environments. The present invention also enables a person's search for another person to be discreet and confidential. Finally, parties in the meeting will know that the other attendees are legitimate, as they will all have the same image.

An aspect of an embodiment of the present invention may also include creating a meeting scenario by a meeting organizer, assigning one or more unique visual images, selecting one or more invitees, transmitting the one or more unique visual images to the device of one or more invitees and displaying the one or more unique images. In one aspect of an embodiment of the present invention, the meeting scenario may include data on the time, location and details of the event or meeting scenario. The location may be presented in word form and/or may be determined by a Global Positioning System (GPS). In an aspect of an embodiment of the present invention, the one or more one unique images may be assigned to the meeting organizer. In another aspect, the one or more one unique images may be created or chosen by the meeting organizer. The transmission of the one or more unique images may be done in a peer to peer fashion, depending on the technology. It may also be done across devices and across systems. The displaying of the one or more unique images may involve projecting the one or more unique images. The projection may be done up against a surface. In another aspect, the displaying of the one or more unique images may involve displaying an arrow to indicate direction. The meeting scenario may be created by the meeting organizer using either a website and/or mobile application.

In an aspect of an embodiment of the present invention, a mobile device application may display (and may project) a unique visual image/animation which is associated with a specific planned meeting between two or more users. The image may be displayed on two or more mobile devices (or on a stationary device if it is associated with a fixed place or business). The image may be displayed in a manner that allows others in the immediate area to see it with normal vision (also including projecting the image on a nearby surface with a light projector). A central system may choose the image, or the meeting organizer may choose it. At the predetermined meeting time (or earlier), the mobile application on devices held by all invited attendees display the meeting image along with other meeting details. This allows attendees to know what visual image to look for at the meeting place (to locate and meet with the other(s)).

An aspect of an embodiment of the present invention may also include maintaining a list of meeting scenarios.

An aspect of an embodiment of the present invention may also include storing the one or more unique images on one or more devices. The device could be that of the meeting organizer or that of the one or more invitees.

An aspect of an embodiment of the present invention may also include ensuring the assignment of distinctly unique images to the one or more invitees.

An aspect of an embodiment of the present invention may also include storing the one or more unique images on a central server.

An aspect of an embodiment of the present invention may also include confirming receipt of the transmitted one or more unique visual images. In an aspect, this may also include maintaining a record of transmissions and receipts of the one or more unique images.

An aspect of an embodiment of the present invention may also include enabling the transmission of text and media attachments. Media attachments may include pictures, documents etc.

Another aspect of an embodiment of the present invention may also include providing directions to the invitee based on the location of the one or more unique image, media or animation.

Another aspect of an embodiment of the present invention may also include viewing the social profile of the one or more invitees.

Another aspect of an embodiment of the present invention may also include checking in. “Checking in” may involve notifying the meeting organizer and the one or more invitees of their proximity to each other. It may alternatively involve notifying said meeting organizer and the one or more invitee of their arrival to said location. It may also, in another aspect, involve scanning the one or more unique images by either of the meeting organizer or the one or more invitees.

Another aspect of an embodiment of the present invention may also include rotating or changing the one or more unique images for the one or more invitees who are yet to arrive for the meeting scenario.

Another aspect of an embodiment of the present invention may also include searching for the one or more unique images that was transmitted and notifying either the meeting organizer or the one or more invitee that the one or more unique images have been located.

Another aspect of an embodiment of the present invention may also include generating a rhythmic vibration on a device of the one or more invitees and matching the one or more unique images that is rhythmically changing once the meeting organizer is close or proximate to the one or more invitees.

In another aspect of an embodiment of the present invention may include computer program product having a computer usable medium with control logic stored on it for causing a computer to use visual media for the determination of a location. The computer program product may include computer readable program code for enabling the creation of a meeting scenario by a meeting organizer, assigning one or more unique visual image specific to the meeting scenario, computer readable program code for selecting one or more invitee, computer readable program code for transmitting the one or more unique visual image to the one or more invitee's device, and computer readable program code for displaying the one or more unique image. In another aspect, the computer program product may additionally include computer program code for enabling the meeting organizer to create or choose the one or more unique visual image.

In another aspect of an embodiment of the present invention, the one or more unique image may be assigned to the meeting organizer.

In another aspect, the computer program product may additionally include computer program code for enabling peer to peer transmission of the one or more unique image.

In another aspect, the computer program product may additionally include computer program code for providing directions to the one or more invitee based on the location of the one or more displayed image.

In another aspect, the computer program product may additionally include computer program code for making the displayed image easier to see by using a formula that adjusts the colors, brightness and/or contrast based upon local ambient conditions.

In yet another aspect of an embodiment of the present invention, the location determination method using visual media may include the steps of creating an event by an event organizer, inviting one or more invitee to the event, assigning a unique image to the organizer and the one or more invitee, locating the unique image, and checking in at the event based on a match between the assigned images. In one aspect, the checking in step may involve scanning the one or more unique image by either of the meeting organizer's device or the one or more invitee's device.

In yet another aspect of an embodiment of the present invention, the method may include the step of notifying the meeting organizer and the one or more invitee of their proximity to each other.

In yet another aspect of an embodiment of the present invention, the method may include the step of notifying the meeting organizer of the one or more invitee's arrival to the event.

In yet another aspect of an embodiment of the present invention, the method may include the step of notifying the one or more invitee that the unique image has been located.

In yet another aspect of an embodiment of the present invention, the method may include the step of rotating or changing the one or more unique image for the one or more invitee who is yet to arrive.

In yet another aspect of an embodiment of the present invention may include computer program product having a computer usable medium with control logic stored on it for causing a computer to use visual media for the determination of a location. The computer program product may include computer readable program code for creating an event by an event organizer, computer readable program code for inviting one or more invitee to the event, computer readable program code for assigning a unique image to the organizer and the one or more invitee, computer readable program code for locating the unique image, and computer readable program code for checking in at the event based on a match between the assigned images. In one aspect, the computer program code for checking in may include computer program code for scanning the one or more unique image by either of the meeting organizer's device or the one or more invitee's device.

In yet another aspect, the computer program product may additionally include computer program code for notifying the meeting organizer and the one or more invitee of their proximity to each other.

In yet another aspect, the computer program product may additionally include computer program code for notifying the meeting organizer of the one or more invitee's arrival to the event.

In yet another aspect, the computer program product may additionally include computer program code for notifying the one or more invitee that the unique image has been located.

In yet another aspect, the computer program product may additionally include computer program code for rotating or changing the one or more unique image for the one or more invitee who is yet to arrive.

A further aspect of an embodiment of the present invention may include inviting the one or more invitees by the meeting organizer. In one aspect, the invitation may be done via email addresses.

A further aspect of an embodiment of the present invention may include scheduling the meeting scenario. In one aspect, this may be done using GPS and the meeting organizer's clock.

A further aspect of an embodiment of the present invention may include sending one or more invitations before the meeting scenario in situations where there is no wireless service at the meeting scenario's location.

A further aspect of an embodiment of the present invention may include registering users with a central server. In one aspect, this may also include confirming one or more users' registrations.

A further aspect of an embodiment of the present invention may include sending the meeting scenario to one or more central servers. In one aspect, this may also include sending one or more invitations to the one or more invitees. In another aspect, his may also include returning one or more unique images for the meeting scenario. This may be illustrated by a meeting organizer “submitting” or “registering” the meeting scenario. At the server, the meeting is assigned a visually unique, identifiable media content (fixed or animated image). The image and confirmation is returned to the meeting organizer, is stored on his mobile device, and is also transmitted to all one or more invitees or meeting invitees. With a central system server, the system can ensure that only distinctly unique images are assigned for a given time and location across different meeting groups. The image and meeting info may then be sent from the device or central server to all the invitees/attendees. The invited parties upon receipt of the image are instructed to look for that image on the meeting organizer's device to locate him/her at the meeting place and time. The parties can be sure they have found the right person/meeting because the images on their devices match.

A further aspect of an embodiment of the present invention may include confirming the submitted meeting scenario.

A further aspect of an embodiment of the present invention may include ensuring the assignment of distinctly unique images for a given time, location and/or meeting group.

A further aspect of an embodiment of the present invention may include generating an image using a set of parameters that are interpreted to calculate or generate an image, media or animation by code or a formula on the display devices. This may be run through a pre-determined formula on a device to generate the image.

A further aspect of an embodiment of the present invention may include making the displayed image easier to see using a formula or code that adjusts the colors, brightness and/or contrast based upon local ambient conditions.

In all respects, embodiments of the present invention present computer program product for enabling all aspects and functionalities described/discussed in this application. Embodiments of the present invention also present one or more systems incorporating and/or enabling all aspects and functionalities described/discussed in this application while also presenting one or more apparatus for enabling all aspects and functionalities described/discussed in this application. In a further embodiment of the present invention, a custom application (e.g. mobile application) or a website running on or without mobile devices may be employed to enable all aspects and functionalities described/discussed in this application. Additionally, devices and/or a central system server may use the computer program product code be part of the system to coordinate the meetings and other aspects of the invention as discussed above. Primarily, the server can ensure that unique images are assigned to the various different meetings.

### BRIEF DESCRIPTION OF THE DRAWINGS

FIG. 1 illustrates a visual media locator system according to an aspect of an embodiment of the present invention.

FIG. 2 illustrates an image assignment phase according to an aspect of an embodiment of the present invention.

FIG. 3 illustrates an event phase following the assignment of images to an event organizer and invitees according to an aspect of an embodiment of the present invention.

FIG. 4 illustrates a process flow reflecting the event setup/creation phase according to an aspect of an embodiment of the present invention.

FIG. 5 illustrates a process flow reflecting the phase before and during the actual event according to an aspect of an embodiment of the present invention.

FIG. 6 illustrates a location showing operation of the mobile application during the scheduled event according to an aspect of an embodiment of the present invention.

### DETAILED DESCRIPTION OF THE INVENTION

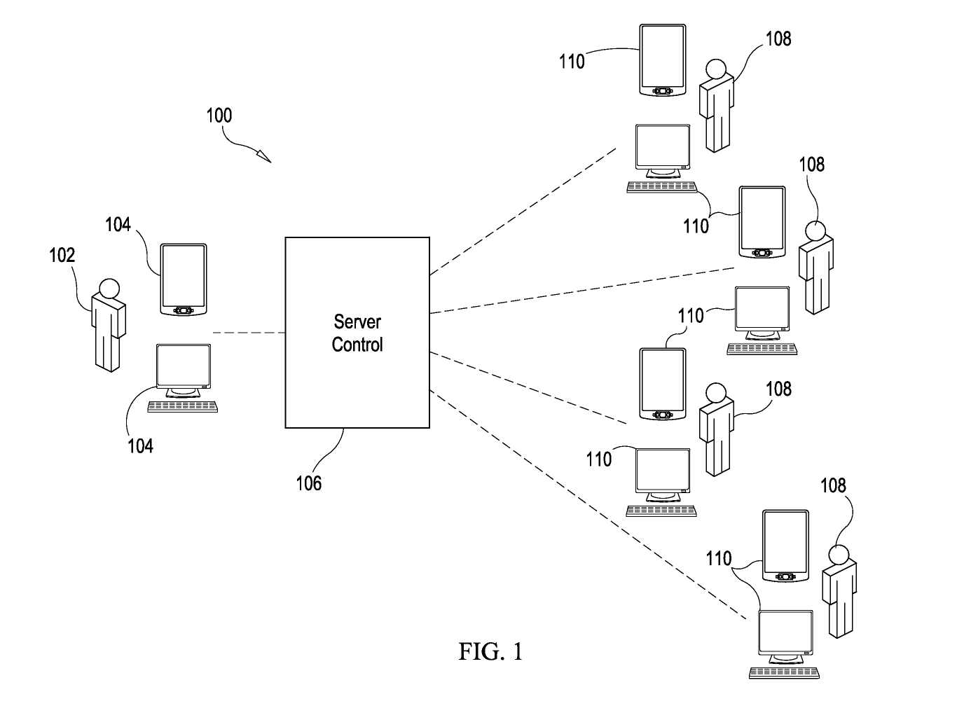

Referring now to FIGS. 1, 2 and 4, a visual media locator system 100, an image assignment phase 200 and a process flow 400 reflecting the event setup/creation phase are all shown according to an aspect of an embodiment of the present invention. Visual media locator system 100 includes event organizer 102, the organizer's device(s) 104, a system server 106 for performing multiple system operations, a number of system user and non-user invitee(s) 108 and the invitee's device(s) 110. Device(s) 104 and 110 may be any one of or a combination of mobile phone(s), tablet(s), portable communication device(s) and/or computers. Server 106 may be in operative communication with device(s) 104 and device(s) 110 in a variety and/or combinations of ways including cellular connections, Voice-Over-Internet Protocol (VoIP) or wireless protocols. The wireless protocols could be one of Cellular, ZigBee, Wireless (802.11a/b/g/n), Wi-Fi, ANT, Bluetooth and Ultra Wide Band (UWB) protocols. In an aspect of an embodiment of the present invention, communication within and without system 100 may include additional intermediary systems, structures and/or devices. In another aspect, server 106 may be one or a combination of servers that also may be part of, or may constitute, a local area network (LAN), wide area network (WAN) or the like.

Event organizer 102 creates an event or meeting using one or a combination of device(s) 104. Organizer 102 would have previously installed the application for system 100. In creating or setting up a new event, organizer 102 creates a event or meeting by entering all pertinent information concerning the event including the event's date, location, time, supplemental information and/or an additional message. Organizer 102 then selects a list of invitees 108 from a contact list which may have been previously created or just created for the purpose of the current meeting. In an aspect of an embodiment of the present invention, organizer 102 may select invitees 108 from a contact list resident on device(s) 104. The event scenario (containing, without limitation, the event's pertinent information and invitee list) is then saved on either of or a combination of device(s) 104 and/or a server 106.

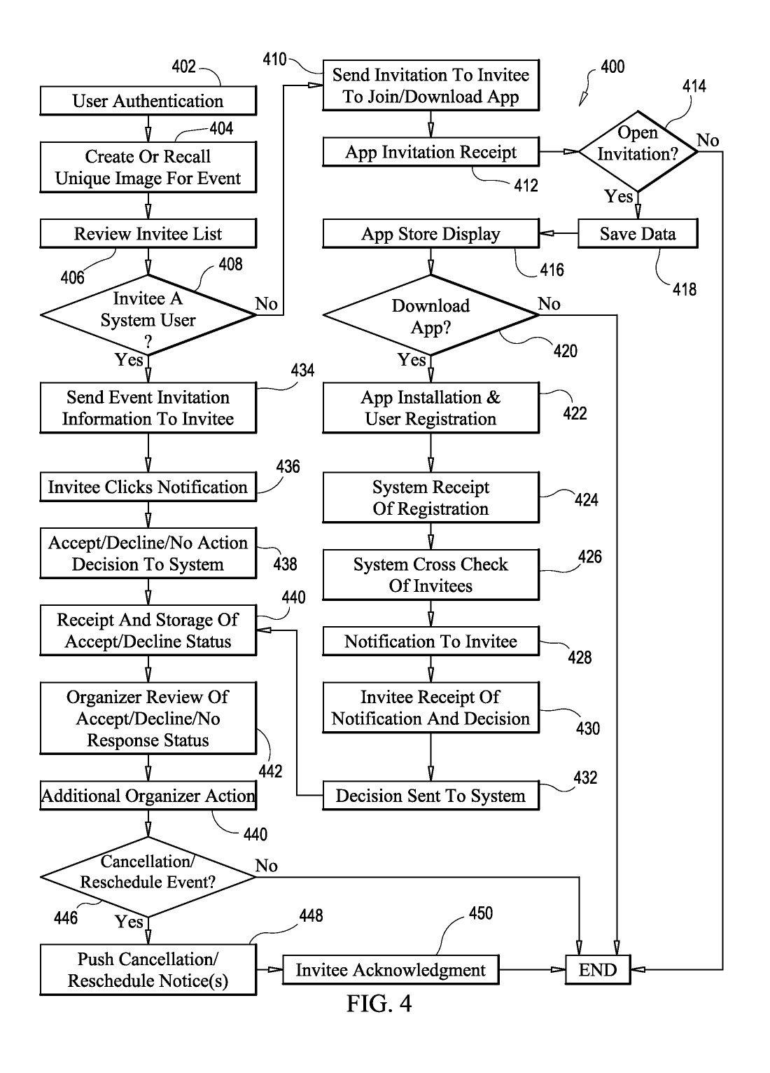

Upon receipt of the event scenario from organizer 102, system 100, using server 106 in step 402 of FIG. 4 then authenticates organizer 102 using one of or a combination of standard authentication methods by checking, inter alia, whether organizer 102 is a bona fide user of system 100 (e.g. by nature of membership, authorization, appropriate age, etc. or the like). System 100 then in step 404 creates a unique image, media or animation, I to be associated with this event. In an aspect of an embodiment of the present invention, a previously created unique image may be recalled and used. Software on server 106 ensures that the image is uniquely identifiable and visually distinct from all other images associated with events in the system that may be in a similar temporal and spatial/geographic context. In another aspect of an embodiment of the present invention, the image/media, I may be totally unique for each person and different across all invitees, so others may not “spoof” or impersonate others' identities at the time of the event.

Server 106 then reviews the invitee list in step 406 to determine in step 408 whether each invitee is a registered user of system 100. This may include, inter alia, whether each invitee is a registered user by way of having downloaded the appropriate application or “App” to their device, whether they are a member of an organization that utilizes system 100, etc or the like. If the invitee is not a user, the process proceeds to step 410. Otherwise, the process flow proceeds to step 434.

If the invitee is not a user, at step 410, server 106 sends an invitation to the non-user invitee's device(s) 110. The invitation may be or may include asking the invitee to join the organization and/or download the App for system 100. The invitation may be sent in a number of ways, including, email, SMS, MMS, or any other method. The invitation may include the image, media or animation I and basic information about the App. The invitation may also request that the invitee install the App in order to view the event details.

Invitee 108 receives the invitation in step 412 and determines in step 414 whether to open the invitation or not. If the invitee does not open the invitation, the process ends. Otherwise, invitee 108 responds positively to the invitation e.g. by clicking on a link within the invitation to get more information on the App—which then directs the invitee to the system website. In one aspect of an embodiment of the present invention, once invitee(s) 108 responds positively, communication of invitee(s) 108's interest in the App is sent to server 106 which then records the same. Server 106 receives the invitee's positive response (which, in one aspect, may be an http “request”) for invitee to review the information in the invitation and install the App. In one aspect of an embodiment of the present invention, the invitation may contain code to obtain invitee information from device(s) 110, with invitee's permission. Server 106 then in step 418 records important information regarding invitee 108 from device(s) 110, including invitee's phone number, demographic information etc. and then displays general App information along with installation instructions. Server 106 may then in step 416 redirect invitee's browser to the App store appropriate for invitee's device, to download the App.

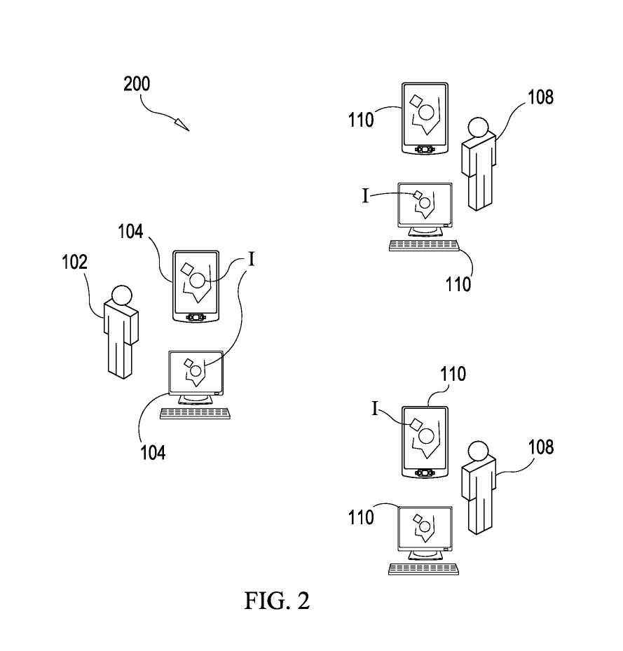

Invitee 108 then decides in step 420 whether to install the App or not. If not, the process ends. Otherwise, if invitee 108 decides to do so, invitee 108 then installs the App in step 422 and registers with system 100 using the same email, phone number or other contact means invitee was invited with. Following invitee's registration in step 422, server 106 receives and stores the registration information in step 424 and then in step 426 cross checks the emails, phone numbers or contact information data against previously stored invitations. Server 106 then (after confirming that invitee 108 was one of organizer 102's invitees) in step 428 pushes a notification to invitee's device(s) 110 that there is an invitation waiting to be read. In one aspect of an embodiment of the present invention, server 106, during this transmission, sends the unique image assigned for the event, I to invitee 108's device(s) 110 as seen in FIG. 2. In one aspect of an embodiment of the present invention, the image, media or animation, I may be sent at the time the event or meeting scenario is received by server 106. In another aspect, image, media or animation, I may be made visible to all parties' device(s) immediately when it is assigned or created by server 106. In yet another aspect, image, media or animation I may be made visible to some or all parties at the event time (or shortly prior). In a yet further aspect, image, media or animation I may be made visible to an invitee(s) 108's device(s) 110 when the device(s) is determined to be at, or close to the event or meeting location.

Invitee 108 may then open the notification and view details of the event and the associated image, media or animation. Invitee 108 can, in step 430, accept the invitation, decline to attend the event or take no action. The App on invitee 108's device(s) 110 then in step 432 sends invitee's decision to server 106 which is received and stored by server 106 in step 440.

Referring back to decision step 408, if invitee 108 was already a user of system 100, server 106 in step 434 may send the event invitation via email, SMS, MMS, or other communication method to invitee 108's device(s) 110. Server 106 may also “push” notification along with unique image, I to invitee 108's device(s) 110. Invitee 108 receives the notification in step 436, opens the invitation and decides whether to accept the invitation, decline to attend the event or take no action. The App on invitee 108's device(s) 110 then sends invitee's decision to server 106 in step 438 which is received and stored by server 106 in step 440. Organizer 102 may, in step 442, view the accepted/declined/no response status of invitees. Organizer 102 may then conduct additional activities as shown in step 444 which may include, without limitation, re-sending the invitations and/or notices to selected invitee(s) 108. Organizer 102, in step 446, may decide whether or not to reschedule or cancel the event. If no, the process ends. Otherwise, server 106 pushes cancellation and/or rescheduling notices to invitees in step 448 which is then in step 450 received and acknowledged by invitee(s) 108 via device(s) 110 after which the process ends

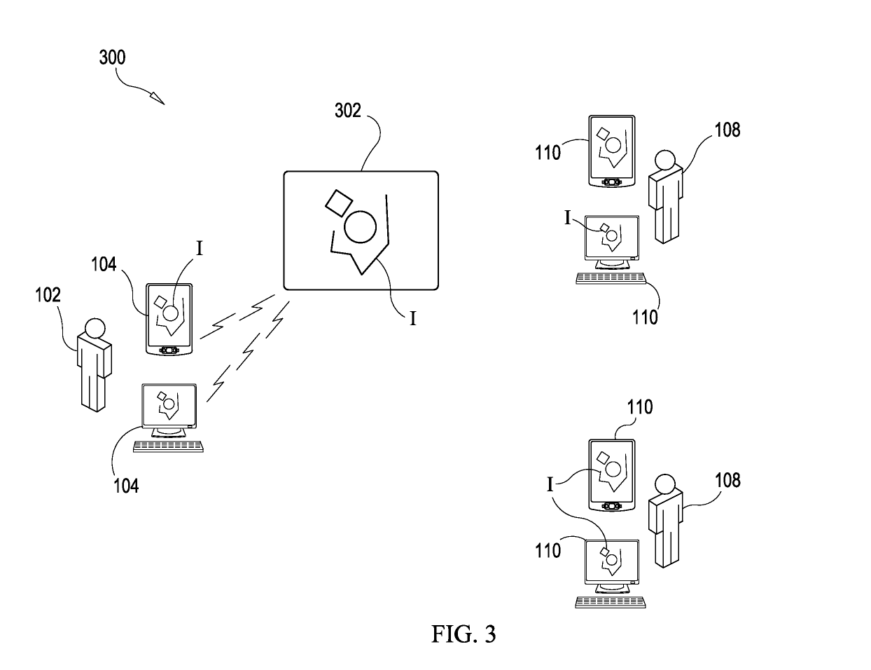

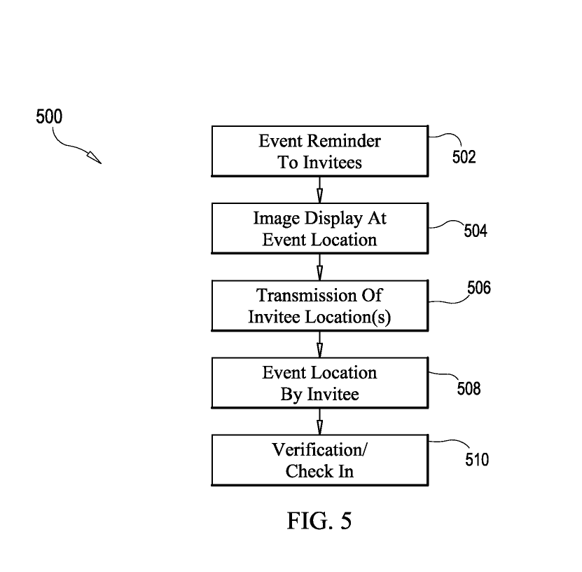

Referring now to FIGS. 3, 5 and 6, an event phase 300 following the assignment of images to an event organizer and invitees, a process flow 500 reflecting the phase before and during the actual event and a location 600, showing operation of the mobile application during the scheduled event all according to aspects of embodiments of the present invention according, are shown. Prior to the event, server 106 may, in step 502 of FIG. 5, send or push reminder information to organizer 102 and invitee(s) 108 when event time is approaching. At the event location 600, organizer 102 displays the unique image, media or animation, I to visually identify the event. Organizer 102, in step 504 may project the image, media or animation, I onto a surface, or display it on a screen, etc. 302 using available technology. This may be done wirelessly using device(s) 104 or in a connected manner. At this point, in an aspect of an embodiment of the present invention, image, media or animation, I may also appear on device(s) 110 as shown in FIG. 3 to enable invitee(s) 108 to locate organizer 102 and/or match the image, media or animation on their phone with that being projected or displayed on 302.

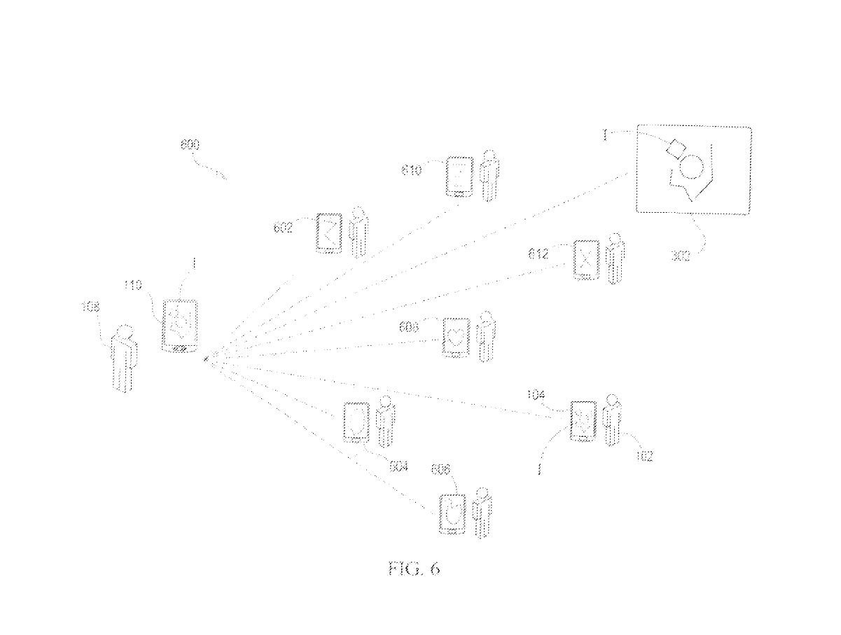

At step 506, at some predetermined time before the event, the system App on device(s) 110 could start transmitting the invitee's location information to system 100 which may be viewed by organizer 102. Organizer 102 may use this to determine invitee(s) 108's proximity to the event. Invitee(s) 108 then in step 508 attends or arrives at the event and locates it as accurately as possible with standard methods, GPS, etc. In one aspect of an embodiment of the present invention, invitee(s) 108 may visually locate the image, media or animation, I shown by organizer 102 to verify he has found the correct person. In another aspect, invitee(s) 108 may visually locate the event image, media or animation I, by scanning the location 600 using a code enabled feature (which may be, in one aspect, a camera on device(s) 110) on device(s) 110 as shown in FIG. 6. Device(s) 110 may use pattern or image recognition code or a variation thereof to scan location 600 allowing, in one aspect of an embodiment of the present invention, for some angular variation of images scanned. In scanning, device(s) 110 may scan individuals, device(s) 104 and 602 through 612 for images displayed therein in an attempt to locate organizer 102. Device(s) 110 may also scan displayed or projected images including display/projection 302. By doing so, Device(s) 110 may detect image, media or animation I on device(s) 104 and/or display/projection 302 and invitee(s) 108 may know that he/she is at the right place and may also identify organizer 102. In step 510, invitee(s) 108 can prove he/she was invited to the event by showing the invitation and image, media or animation, I on device(s) 110, which displays the same image/media, I. In an aspect of an embodiment of the present invention, invitee(s) 108's image, media or animation may be totally unique and assigned only to invitee 108, so others may not “spoof” his/her identity.

Although this present invention has been disclosed with reference to specific forms and embodiments, it will be evident that a great number of variations may be made without departing from the spirit and scope of the present invention. For example, steps may be reversed, equivalent elements may be substituted for those specifically disclosed and certain features of the present invention may be used independently of other features—all without departing from the present invention as defined in the appended claims.

What is claimed is:

1. A location method using visual media, comprising the steps of:
creating a meeting scenario by a meeting organizer;
assigning at least one unique visual image specific to said meeting scenario;
selecting at least one invitee;
transmitting said at least one unique visual image to said at least one invitee's device; and
displaying said at least one unique image.

2. The method according to claim 1, wherein the said at least one unique visual image is created or chosen by the meeting organizer.

3. The method according to claim 1, wherein the said at least one unique image is assigned to the meeting organizer.

4. The method according to claim 1, wherein the step of transmitting the said at least one unique image is done peer to peer.

5. The method according to claim 1, further comprising the step of providing directions to said at least one invitee based on the location of said at least one displayed image.

6. The method according to claim 1, further comprising the step of making the displayed image easier to see by using a formula that adjusts the colors, brightness and/or contrast based upon local ambient conditions.

7. A computer program product comprising a computer usable medium having control logic stored therein for causing a computer to use visual media for the determination of a location, comprising:
computer readable program code for enabling the creation of a meeting scenario by a meeting organizer;
computer readable program code for assigning at least one unique visual image specific to said meeting scenario;
computer readable program code for selecting at least one invitee;
computer readable program code for transmitting said at least one unique visual image to said at least one invitee's device; and
computer readable program code for displaying said at least one unique image.

8. The computer program product according to claim 7, further comprising computer program code for enabling the meeting organizer to create or choose said one unique visual image.

9. The computer program product according to claim 7, wherein the said at least one unique image is assigned to the meeting organizer.

10. The computer program product according to claim 7, further comprising computer program code for enabling peer to peer transmission of said at least one unique image.

11. The computer program product according to claim 7, further comprising computer program code for providing directions to said at least one invitee based on the location of said at least one displayed image.

12. The computer program product according to claim 7, further comprising computer program code for making the displayed image easier to see by using a formula that adjusts the colors, brightness and/or contrast based upon local ambient conditions.

13. A location method using visual media comprising the steps of:
creating an event by an event organizer;
inviting at least one invitee to said event;
assigning a unique image to said organizer and said at least one invitee;
locating said unique image; and
checking in at said event based on a match between said assigned images.

14. The method according to claim 13, further comprising the step of notifying said meeting organizer and said at least one invitee of their proximity to each other.

15. The method according to claim 13, further comprising the step of notifying said meeting organizer of said at least one invitee's arrival to said event.

16. The method according to claim 13, further comprising the step of notifying said at least one invitee that said unique image has been located.

17. The method according to claim 13, wherein the step of checking in comprises of scanning said at least one unique image by either of said meeting organizer's device or said at least one invitee's device.

18. The method according to claim 13, further comprising the step of rotating or changing said at least one unique image for said at least one invitee who is yet to arrive.

19. A computer program product comprising a computer usable medium having control logic stored therein for causing a computer to use visual media for the determination of a location, comprising:
computer readable program code for creating an event by an event organizer;
computer readable program code for inviting at least one invitee to said event;
computer readable program code for assigning a unique image to said organizer and said at least one invitee;
computer readable program code for locating said unique image; and
computer readable program code for checking in at said event based on a match between said assigned images.

20. The computer program product according to claim 19, further comprising computer program code for notifying said meeting organizer and said at least one invitee of their proximity to each other.

21. The computer program product according to claim 19, further comprising computer program code for notifying said meeting organizer of said at least one invitee's arrival to said event.

22. The computer program product according to claim 19, further comprising computer program code for notifying said at least one invitee that said unique image has been located.

23. The computer program product according to claim 19, wherein said computer program code for checking in comprises of computer program code for scanning said at least one unique image by either of said meeting organizer's device or said at least one invitee's device.

24. The computer program product according to claim 19, further comprising computer program code for rotating or changing said at least one unique image for said at least one invitee who is yet to arrive.
